(19) United States
(12) Patent Application Publication
(10) Pub. No.: US 2019/0090473 A1
(43) Pub. Date: Mar. 28, 2019

(54) Wild Game Feeder

(71) Applicant: The Marbella Group LP, Trophy Club, TX (US)

(72) Inventor: Larry West, Trophy Club, TX (US)

(21) Appl. No.: 16/139,048

(22) Filed: Sep. 23, 2018

Related U.S. Application Data
(60) Provisional application No. 62/562,706, filed on Sep. 25, 2017.

(51) Int. Cl. A01M 31/00; A01M 29/30; A01K 5/02

(52) U.S. Cl. CPC A01M 31/008; A01K 5/0225; A01M 29/30

(57) ABSTRACT

An add-on accessory kit to a broadcast feeder having a motor-driven spinner mechanism disposed below a feed funnel coupled to a feed container, where the accessory kit includes a top plate configured for mounting below the feed funnel and above the spinner mechanism, a bottom plate configured for mounting narrowly spaced from the top plate below the spinner mechanism, the narrow space between the top and bottom plates preventing access by varmint, and a plurality of fasteners configured for attaching at least one of the top and bottom plates below the feed container, so that feed dropping from the feed container and scattered by the spinner mechanism achieves a farther broadcast distance. A broadcast feeder can also be manufactured and sold with the add-on accessory integrated therewith.

### RELATED APPLICATION

The present application claims the benefit of U.S. Provisional Patent Application Ser. No. 62/562,706, filed on Sep. 25, 2017, which is incorporated herein by reference.

### FIELD

The present disclosure primarily relates to broadcast feeders, and more particularly to a device that protects the broadcast mechanism of a wild game feeder from varmint.

### BACKGROUND

Hunters use broadcast-type feeders that scatter feed and supplements to attract wild game to a certain location. Typical game feeders use a spinner mechanism that flings and distributes feed as it drops down from a container or barrel. However, varmint such as racoons can easily reach the spinner plate of these feeders and quickly empty the contents of the entire feeder prematurely. Conventional feeder protection schemes use a wired enclosure around the spinner mechanism. These wired enclosures do not effectively prevent access by the racoons and, more importantly, obstruct the trajectory path of the scattered feed.

### DESCRIPTION OF THE DRAWINGS

FIG. 1 is a partial perspective view of an exemplary embodiment of a protected wild game feeder scatter mechanism according to the teachings of the present disclosure;

FIG. 2 is a partial side view of an exemplary embodiment of a protected wild game feeder scatter mechanism according to the teachings of the present disclosure;

FIG. 3 is a perspective view of an exemplary embodiment of the protected wild game feeder according to the teachings of the present disclosure;

FIGS. 4A-4D are various views of exemplary embodiments of the parts of the protected wild game feeder scatter mechanism according to the teachings of the present disclosure;

FIGS. 5A-5F are side view illustrations of the various embodiments of the top and bottom plates of the protected wild game feeder scatter mechanism according to the teachings of the present disclosure; and

FIG. 6 is a side view of an exemplary embodiment of a protected ground-fill type wild game feeder according to the teachings of the present disclosure.

### DETAILED DESCRIPTION

The device described herein can be added and retrofitted onto a raised or ground-fill broadcast-type feeder or be integrally-incorporated and sold as part of a broadcast-type feeder. Raised broadcast feeders typically have legs that elevate the feed barrel and spinner mechanism six to seven feet above the ground. Ground-fill type broadcast feeders typically have a feed barrel that sits on top of a base with the spinner mechanism sitting two to three feet from the ground. All feeders, including the raised and ground-fill types, that use a spinner mechanism to distribute and spread feed from a feed box or barrel can be modified to protect against tampering by varmints and also increase the broadcast distance of the feed. The protection mechanism disclosed herein has dual purposes: achieve a wider broadcast distance while protecting the feeder from tampering by varmint.

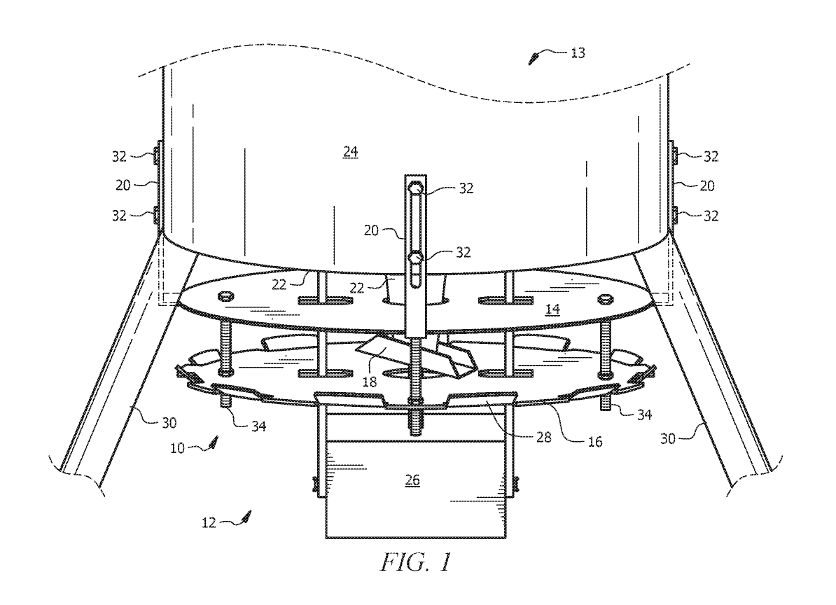

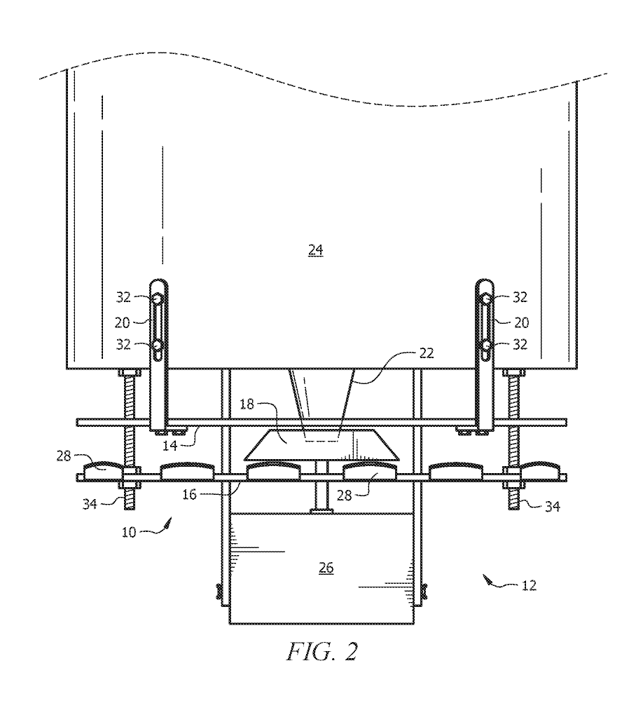

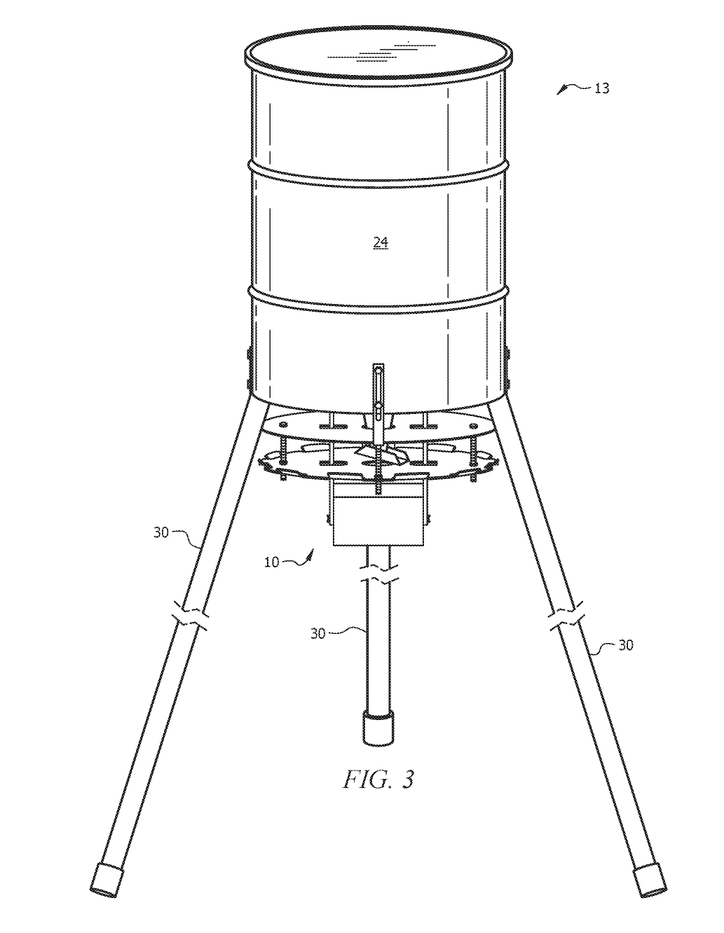

FIGS. 1 and 2 are perspective and side views, respectively, of exemplary embodiments of a protection mechanism 10 for a scatter device 12 of a raised wild game feeder 13 according to the teachings of the present disclosure. FIG. 3 is a perspective view of the entire feeder 13 with the protected scatter mechanism 12. A top disc or circular plate 14 and a bottom disc or circular plate 16 are added to sandwich the spinner mechanism 18 of the feeder 13 using fasteners such as L-brackets 20. The spinner mechanism 18 is typically a plate that is mounted beneath an opening in the feed box/barrel/bin/container/hopper 24. A funnel 22 may be coupled to and disposed below the feed barrel opening to catch and guide the falling feed to the spinner plate. In some feeders, the funnel is integrally incorporated so that the shape of the feed barrel function as a funnel. The spinner mechanism 18 is coupled to a motor (not explicitly shown) powered by a battery (not explicitly shown), both housed inside a control box 26. The battery may be rechargeable by solar technology. The distance or gap between the top and bottom plates 14 and 16 can be adjusted by the user to accommodate a variety of spinner mechanism configurations present in wild game feeders on the market. The top plate 14 and bottom plate 16 are preferably sized so that a varmint, such as a racoon, is blocked from reaching the spinner plate located at the center below the funnel 18 between the plates 14 and 16. Either or both plates may have a plurality of flanges 28 around the circumference. The use of the top and bottom plates 14 and 16 restricts access by varmints so that the contents of the feeder are not prematurely depleted and wasted. Further, the bottom plate 16 and its circumferential upward flaring flanges 28 greatly increase the broadcast distance due to the upward trajectory angle without making any modification to the spinner mechanism 18 and motor 26. The combination of the upward flanges and straight edges of the bottom plate causes the scattered feed to have both an inner scatter radius and an outer scatter radius, resulting in a better and farther distribution of the feed. The barrel 24 of the feeder 13 may be supported on three or more legs 30 or may be suspended from an overhang structure. The feed barrel 24 may be of any shape and dimension.

The top and bottom plates 14 and 16 can be any shape but are preferably circular, and the plates are sized so that varmint cannot reach the spinner plate. The top and bottom plates may be in shapes other than circular, and can be square, rectangular, pentagonal, hexagonal, etc. The plates are preferably identical in size and shape, but can be different in either size or shape.

As shown in FIGS. 1 and 2, the top plate 14 may be affixed to the feed barrel 24 using fasteners such as L-brackets 20 and bolts 32, and the bottom plate 16 may be fastened to the top plate 14 using a plurality of fasteners 34 around the circumference of the plates 14 and 16. Alternatively, the bottom plate 16 can be affixed to the spinner plate control box 26, and the top plate 14 can be fastened to the bottom plate 16 using a plurality of fasteners around the circumference of the plates 14 and 16. The distance between the two plates 14 and 16 can be adjusted to accommodate the spinner mechanism 18. Ideally, the top and bottom plates are no more than one inch apart. The narrow spacing between the two plates 14 and 16 and the dimension of the plates prevent varmint from gaining access to the spinner mechanism 18 and the feed funnel 22.

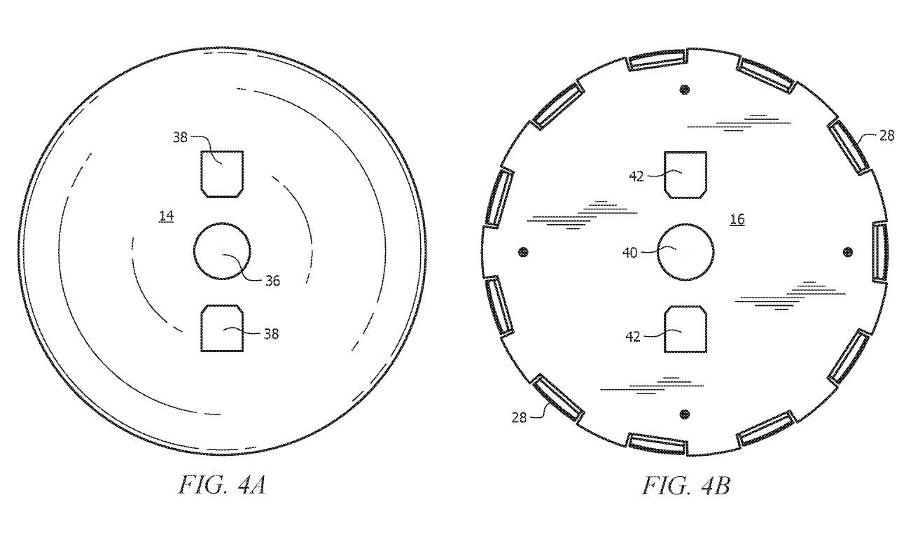

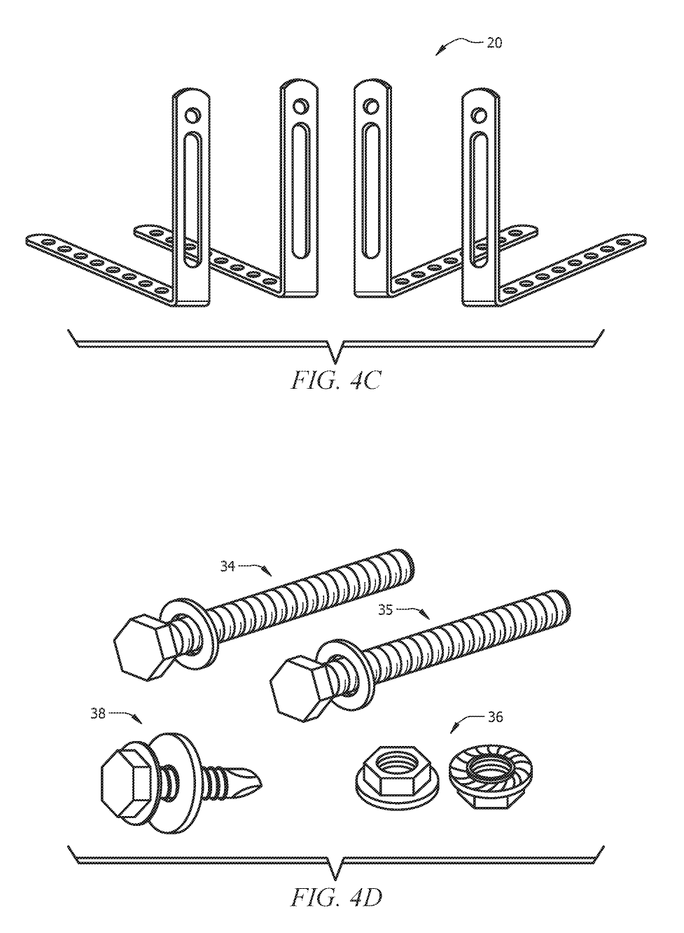

FIG. 4A is a top view of an embodiment of a circular top plate 14 of the protected wild game feeder scatter mechanism according to the teachings of the present disclosure. As shown in FIG. 4A, the top plate 14 has a center opening 36 to accommodate the feed funnel 22, and two additional openings 38 flanking the center opening 36 to accommodate the supports of the motor control box 26. Alternatively, the top plate 14 may define a single opening or slot that is dimensioned to accommodate the feed funnel, spinner mechanism, and control box supports more precisely. The top plate 14 may be flat or may have a specific contour, such as having a concave or convex profile.

FIG. 4B is a diagram of top and side views of an embodiment of a bottom plate 16 of the protected wild game feeder scatter mechanism according to the teachings of the present disclosure. The bottom plate 16 may be a flat circular plate or may incorporate a plurality of flanges 26 extending at, e.g., approximately 30-degree angle from the plane of the plate 16. Alternatively, the bottom plate 16 may be manufactured to have a flared circumferential edge at a 30-degrees angle from the plane of the plate 16. The bottom plate 16 also has a center opening and lateral openings 40 and 42 to accommodate the spinner mechanism 18 and the supports of the control box 26. The bottom plate 16 may also define a single opening or slot that is dimensioned to accommodate the feed funnel, spinner mechanism, and control box supports more precisely. The bottom plate 16 may be flat or may have a specific contour, such as having a concave or convex profile.

FIGS. 4C and 4D show additional components of the protection mechanism 10 for the wild game feeder scatter device 12 that include plurality of L-brackets 20. Each L-bracket 20 has an elongated slot and a single hole on one leg and a series of holes on the second leg. The slot enables vertical adjustment to accommodate a variety of funnel sizes and repositioning during and after installation. To correctly position the plates 14 and 16 to the spinner mechanism 18, the series of holes in the L-bracket 20 are used to fasten to the top plate 14 and allow positioning options to accommodate various sized feeder barrels 24, and prevent both plates from moving horizontally due to vibrations and movement of varmints. The position of the plates is fixed once the nuts 36 (FIG. 4D) are tightened. The single hole on the slotted leg of the L-bracket 20 is used to fasten to the feed barrel 24 to prevent vertical movement from vibrations and varmints climbing around. FIG. 4D also shows fasteners 34 used to attach the bottom plate 16 to the top plate 14, and fasteners 38 used to attach the L-brackets 20 to the feed barrel 24.

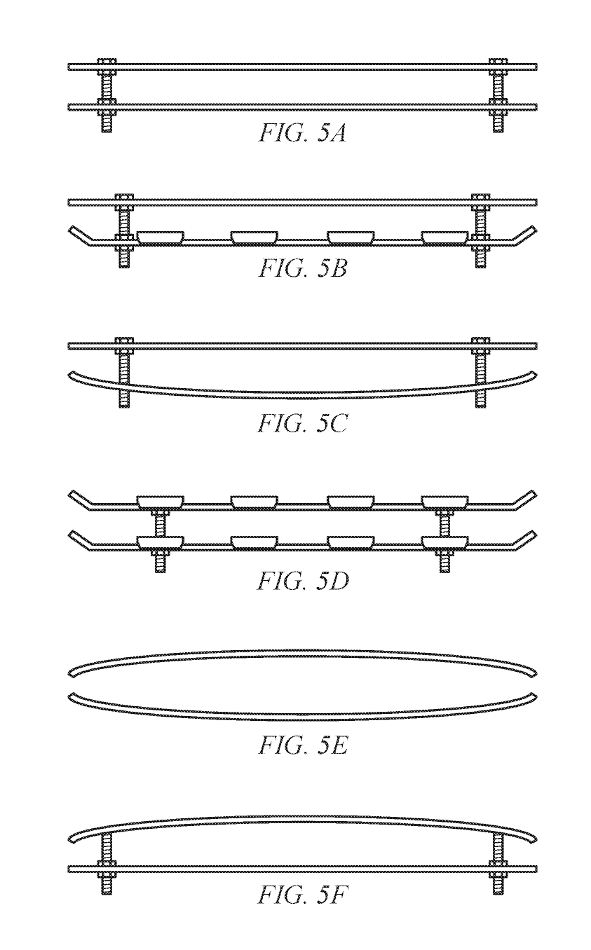

FIGS. 5A-5F show various exemplary embodiments of the top and bottom plates of the protection mechanism 10 for the wild game feeder scatter device 12 according to the teachings of the present disclosure. The top plate can be planar (flat) and concave, with or without intermittent or circumferential flange(s). The bottom plate can be planar, with intermittent circumferential flanges, or a flange that span the entire circumferential edge, and concave. Some of the potential top and bottom plate combinations are shown in FIGS. 5A-5F. Other configurations are also contemplated.

The protection mechanism 10 may be sold as an add-on accessory kit for a raised wild game feeder 13 or be integrated with the broadcast mechanism of a feeder 13. The add-on accessory kit can be used to modify a raised broadcast feeder to protect against raiding by varmints and to increase the broadcast radius. As shown in FIGS. 4A-4D, the add-on kit preferably includes a top plate with a diameter approximately 22.250 inches (14), bottom plate with a diameter approximately 22.250 inches (16), four 5½″×5½″ L-brackets (20), four ¼″-20×2½″ hex head serrated flange full thread bolt (34), two ¼″-20×4″ hex head serrated flange full thread bolt (35), twelve ¼″-20 serrated nut (36), and eight ¼″-14¾″ self-drilling bolt with neoprene washer (38). It should be noted that the above specifications are given as an example only, and any configuration and arrangement of fasteners may be used to couple the top and bottom plates to the broadcast mechanism and/or the feed barrel of the feeder. When the dual-plate protection device is integrally constructed with the feeder broadcast mechanism, the manner in which the two plates are fastened or constructed relative to the broadcast mechanism can be vastly different than described herein.

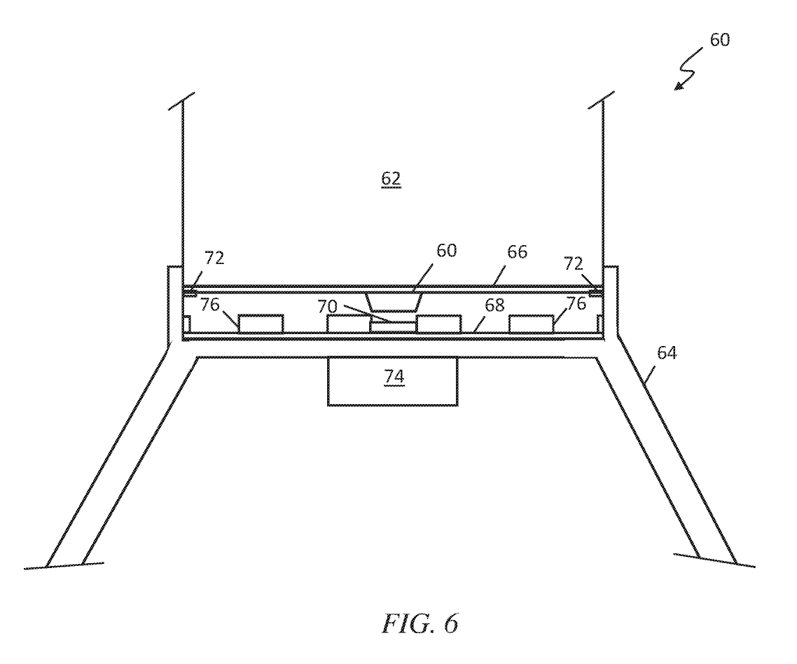

FIG. 6 is a side view of an exemplary embodiment of a protected ground-fill type wild game feeder 60 according to the teachings of the present disclosure. The ground-fill type feeder 60 includes a feed barrel/bin/container/hopper/box 62 that sits in a base 64 with a square footprint that elevates the feed barrel 62 approximately three to four feet above the ground so that it can be more easily filled without a ladder. The base 64 may include four legs that provide stable support for the feed barrel 62. The feed barrel 62 may be secured to the base 64 by a plurality of bolts (not shown). A top plate 66 and a bottom plate 68 are disposed below an opening of the feed barrel 62 and sandwich the spinner plate 70 that function to scatter feed falling from the feed barrel 62. The plates 66 and 68 may sit on shelves 72 formed in the base 64 that define the narrow space between them. The spinner plate 70 is mechanically coupled to a motor (not explicitly shown) powered by a battery (not explicitly shown), both housed inside a control box 74 that is typically coupled to the base 64 below the spinner plate 70. The battery may be rechargeable by a solar panel (not shown). The top and bottom plates 66 and 68 are preferably square in shape for this embodiment as the base 64 has a square footprint. It should be noted that the top and bottom plates can have other shapes that function well with the base. The bottom plate 68 is shown to have a plurality of upwardly angled flanges 76 that function to cause the scattered feed to have an upward and outward trajectory, which results in a much wider broadcast radius, and a better distribution of the feed. As described above, the contour and construction of the top and bottom plates may take on a number of different configurations and combinations, including having a bottom plate that is contoured to have a continuous upwardly angled edge around its entire perimeter.

It should be noted that in some embodiments, the top plate 66 is optional as the narrow spacing between the bottom of the feed container and the bottom plate 68 may function to eliminate or minimize access by varmint.

Although the present disclosure places emphasis on gravity-fed raised tripod broadcast feeders, the dual-plate construction is equally applicable to other types of feeders such as feeders where the funnel is contained within the feed barrel or incorporated as part of the barrel, as long as a spinner broadcast mechanism is used to scatter the feed. The two plates can be used to sandwich the broadcast mechanism, where the spacing between the two plates and the dimension of the plates work together to keep the feed out of reach of varmints, and the flange(s) on the bottom plate function to propel the feed to much greater distances and achieve a better distribution of the feed.

The features of the present invention which are believed to be novel are set forth below with particularity in the appended claims. However, modifications, variations, and changes to the exemplary embodiments of the wild game feeder protection device described above will be apparent to those skilled in the art, and the protection device described herein thus encompasses such modifications, variations, and changes and are not limited to the specific embodiments described herein.

What is claimed is:

1. A broadcast feeder comprising:
a container configured for storing feed;
a feed funnel coupled to an opening in the container configured to receive and guide feed falling from the container due to gravity;
a motor-driven spinner mechanism disposed below the feed funnel;
a top plate with an opening for accommodating the feed funnel, where the top plate is mounted above the spinner mechanism; and
a bottom plate having at least one angled flange at its outer edge mounted below the spinner mechanism and narrowly spaced from the top plate.

2. The wild game broadcast feeder of claim 1, wherein the bottom plate is circular in shape and comprises an upwardly angled edge around its entire circumference.

3. The wild game broadcast feeder of claim 1, wherein the bottom plate comprises a plurality of upwardly angled flanges around its outer edge.

3. The broadcast feeder of claim 1, wherein at least one of the top and bottom plates is concave.

4. The broadcast feeder of claim 1, wherein at least one of the top and bottom plates is planar.

5. The broadcast feeder of claim 1, wherein the top and bottom plates have a shape selected from the group consisting of circular, square, rectangular, pentagonal, and hexagonal.

6. The broadcast feeder of claim 1, wherein the top and bottom plates each comprises a central opening for accommodating the spinner mechanism and feed funnel, and a plurality of lateral openings for accommodating supports for the control box.

7. An add-on accessory to a broadcast feeder having a motor-driven spinner mechanism disposed below an opening of a feed container comprising:
a top plate configured for mounting above the spinner mechanism; and
a bottom plate configured for mounting narrowly spaced from the top plate below the spinner mechanism, the bottom plate having at least one upward angled outer flange.

8. The add-on accessory of claim 7, wherein the bottom plate comprises a series of upwardly angled circumferential flanges.

9. The add-on accessory of claim 7, wherein the bottom plate comprises an upwardly angled flange around its entire outer edge.

10. The add-on accessory of claim 7, wherein at least one of the top and bottom plates is concave.

11. The add-on accessory of claim 7, wherein at least one of the top and bottom plates is planar.

12. The add-on accessory of claim 7, wherein the top and bottom plates have a shape selected from the group consisting of circular, square, rectangular, pentagonal, and hexagonal.

13. The add-on accessory of claim 7, wherein the top and bottom plates each comprises a central opening for accommodating the spinner mechanism and feed funnel, and two lateral openings for accommodating supports for the control box.

14. The add-on accessory of claim 7, wherein at least one of the top and bottom plates is coupled to the feed container by a plurality of fasteners.

15. The add-on accessory of claim 7, wherein spacing between the top and bottom plates is adjustable.

16. A support base for a feed container of a broadcast feeder having a motor-driven spinner mechanism disposed below the feed container, the support base comprising:
a base having at least three legs; and
a first plate having at least one upward angled outer flange disposed in and supported by the base narrowly spaced from the feed container and below the spinner mechanism, the narrow space between the feed container and the first plate preventing access by varmint.

17. The support base of claim 16, wherein the first plate comprises a series of upwardly angled circumferential flanges.

18. The support base of claim 16, wherein the first plate comprises an upwardly angled circumferential edge around its entire perimeter.

19. The support base of claim 16, further comprising a second plate disposed below the feed container and above the spinner mechanism and the first plate, wherein the second plate defines a central opening that accommodates a feed funnel coupled to the feed container, where narrow spacing between the first and second plates prevents access by varmint.
